(19) United States
(12) Patent Application Publication
(10) Pub. No.: US 2009/0271548 A1
(43) Pub. Date: Oct. 29, 2009

(54) INTERRUPT RESPONSE CONTROL APPARATUS AND METHOD THEREFOR

(75) Inventors: Steven McAslan, Glascow (GB); Carl Culshaw, Glascow (GB); John William Doyle, Falkirk (GB); Tracy McHenry, Glascow (GB)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/304,856

(22) PCT Filed: Jun. 23, 2006
(86) PCT No.: PCT/EP2006/063517

§ 371 Date: Dec. 15, 2008

(51) Int. Cl. G06F 13/24

(52) U.S. Cl. 710/260

(57) ABSTRACT

An interrupt response control apparatus comprises an input for receiving an interrupt request. A response monitoring module is arranged to detect performance of a first function in response to the interrupt request. A timer is used to determine whether a period of time has elapsed, and if the interrupt request has not been serviced by the first function within the elapsed period of time, a function initiation module initiates a second function in response to failure to provide the first function within the elapsed period of time.

### FIELD OF THE INVENTION

This invention relates to an interrupt response control apparatus of the type that, for example, controls response of a processing resource to an interrupt request. This invention also relates to a method of responding to an interrupt request of the type that, for example, controls response of a processing resource to an interrupt request.

### BACKGROUND OF THE INVENTION

In the field of the embedded applications, a correct behaviour of a microcontroller typically depends, inter alia, upon a timely response to an external stimulus. Indeed, failure by the microcontroller to respond to an event within an expected time frame can result in serious malfunction of a system that is under the control of the microcontroller. In this respect, response time of the microcontroller is dependent upon hardware and software design and can be an extremely complex value to predict.

Hence, for some embedded applications, a maximum time limit is typically attributed to a given external stimulus, and failure by the microcontroller in some circumstances to respond to the given external stimulus within the maximum time limit results in incorrect performance of the system. In such circumstances, it is desirable to place the microcontroller in a known “safe” state. In other circumstances, failure by the microcontroller to respond to the external stimulus within the maximum time limit can result in the external stimulus becoming invalid after expiry of the maximum time limit. Consequently, providing a response to the external stimulus that is no longer valid can also cause the system to behave incorrectly.

In order to overcome such problems described above, it is known to design microcontrollers with additional external watchdog functions or elaborate internal software defensive measures. In this respect, US 2005/0114463 A1 relates to a multi-microprocessor apparatus having a slave reset mechanism. A two microprocessor system is disclosed in which a master microprocessor has an ability to reset a slave microprocessor in the event that the slave microcontroller delays response to the master microprocessor. However, the above configuration requires additional hardware, i.e. the master microprocessor, in order to perform a reset function, which can be an excessive (and costly) way to handle some delay situations.

U.S. Pat. No. 6,865,688 discloses a system in which a system reset interrupt is delayed, by software, from taking effect. Without the delay, the system would respond immediately to the interrupt, but the delay is necessary to ensure normal operation of the system. As indicated above, it is desirable to avoid delays and certainly the intentional addition of delays in order to prevent malfunction of the module.

US 2005/0132096 A1 relates to a system having on-chip peripherals capable of issuing interrupts to a processor. The respective urgencies associated with the interrupts can be adjusted depending upon a current (workload) state of the processor, primarily for power-saving purposes. Such adjustment of interrupt priorities occurs in readiness for handling of the interrupts by the processor, the interrupts being externally generated and no change to priority of the interrupt being made thereafter.

### STATEMENT OF INVENTION

According to the present invention, there is provided an interrupt response apparatus and a method of responding to an interrupt request as set forth in the appended claims.

### BRIEF DESCRIPTION OF THE DRAWINGS

At least one embodiment of the invention will now be described, by way of example only, with reference to the accompanying drawings, in which:

FIG. 1 is a schematic diagram of a washing machine comprising an embedded microcontroller constituting an embodiment of the invention;

FIG. 2 is a schematic diagram of an interrupt response control apparatus supported by the microcontroller of FIG. 1; and

FIG. 3 is a flow diagram of a method of responding to an interrupt request for the embedded microcontroller of FIG. 1.

### DESCRIPTION OF PREFERRED EMBODIMENTS

Throughout the following description identical reference numerals will be used to identify like parts.

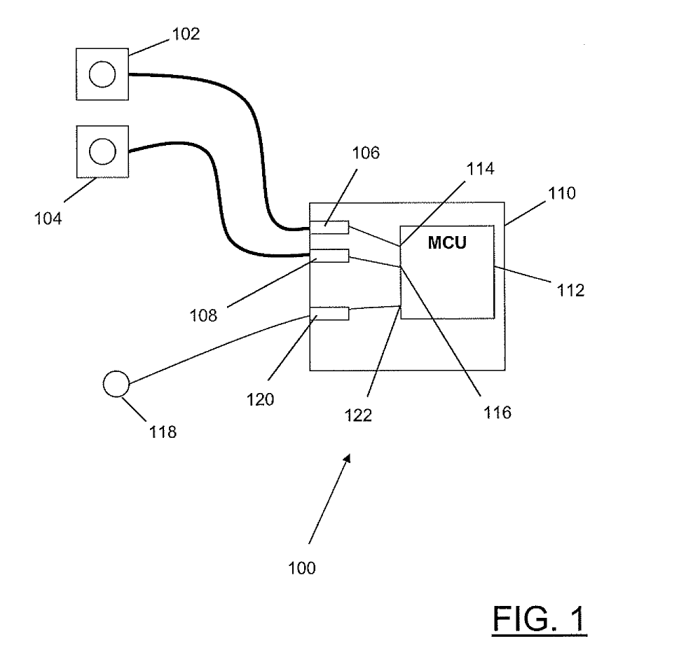

Referring to FIG. 1, a washing machine 100 comprises a first solenoid valve 102 and a second solenoid valve 104 respectively coupled to a first terminal 106 and a second terminal 108 on a circuit board 110. A MicroController Unit (MCU) 112 is electrically connected to the circuit board 110. A first port 114 of the MCU 112 and a second port 116 of the MCU 112 are electrically connected to the first and second terminals 106, 108, respectively, by virtue of tracks (not shown) of the circuit board 110.

A water level sensor 118 is coupled to a third terminal 120 of the circuit board 110, the third terminal 120 also being coupled to a third port 122 of the MCU 112 by the tracks (not shown) of the circuit board 110.

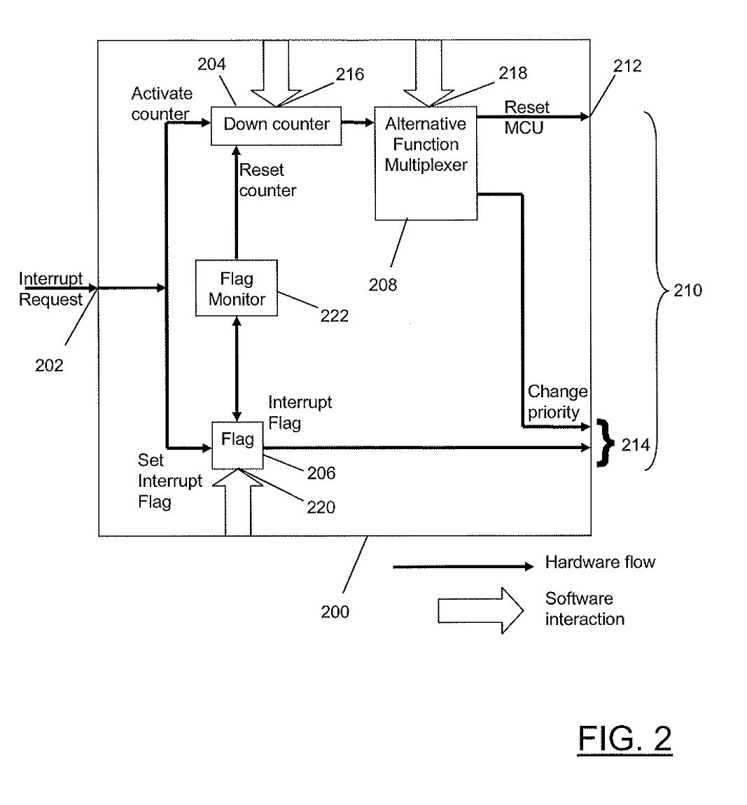

Turning to FIG. 2, the MCU 112 supports an interrupt response control module 200 comprising an input 202 for receiving an interrupt request triggered by a stimulus external to the interrupt control module 200. The input 202 is coupled to a down-counter unit 204 and an interrupt flag unit 206. The down-counter unit 204 is coupled to an alternative function multiplexer unit 208, the alternative function multiplexer unit 208 and the interrupt flag unit 206 being coupled to an output 210 of the interrupt response module 200.

The output 210 comprises a reset port 212 and an interrupt control port 214. In order to provide the interrupt response control module 200 with a degree of configurability, the down-counter unit 204 comprises a first configuration port 216 and the alternative function multiplexer unit 208 comprises a second configuration port 218. The interrupt flag unit 206 comprises a clear port 220 and is also coupled to a flag monitor unit 222, the flag monitor unit 222 also being coupled to the down-counter unit 204.

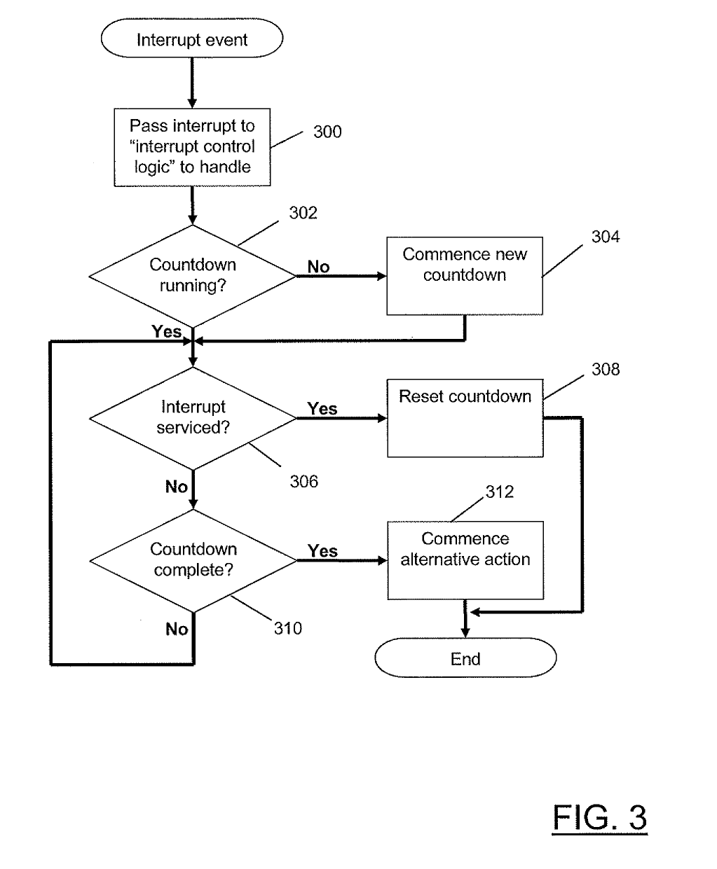

In operation (FIG. 3), the first and/or second solenoid valves 102, 104 are typically actuated to cause a drum (not shown) of the washing machine 100 to fill with water, for example hot and cold water, under the control of the MCU 112. Since initiation of the supply of water to the drum does not relate directly to the present example, the process supported by the MCU 112 to open the first and/or second solenoid valves 102, 104 will not be described herein in order to preserve conciseness and clarity of description.

Under normal operating conditions, the drum is allowed to fill with a known volume of water to achieve optimum cleaning performance. In order to determine when the known volume of water has been delivered to the drum, the water level sensor 118 is arranged to send a feedback signal, constituting the external stimulus, to the MCU 112 once the known volume of water is present in the drum. In the present example, the external stimulus is a digital signal constituting an interrupt request.

As a result of generation of the interrupt request, a valve shutoff process (not shown) supported by the MCU 112, responds to the interrupt request by closing the first and/or second valves 102, 104, thereby halting supply of water to the drum.

However, in the event of system failure, for example due to incorrect behaviour of software supported by the MCU 112, the feedback signal may be ignored by the valve shutoff process, and the first and/or second valves 102, 104 would remain open resulting in flooding.

Consequently, when the interrupt request is generated, the feedback signal is passed (Step 300) using any suitable known hardware routing technique to the interrupt response control module 200. At the input 202, the interrupt request is received and the interrupt response control module 200 determines (Step 302) whether the down-counter unit 204 is already measuring an elapsed period of time in relation to the interrupt request. If the down-counter unit 204 is not already running for the interrupt request, the interrupt response control module 200 analyses the interrupt request in order to determine the nature of the interrupt request and an elapsed time limit, either pre-stored in hardware or user definable, associated with the interrupt request. The interrupt response control module 200 then programmes the down-counter unit 204 with the elapsed time limit via the first configuration port 216.

Thereafter, the down-counter unit 204 begins to count down the elapsed time limit. Periodically, the flag monitor unit 222 of the interrupt response control module 200 determines (Step 306) whether the interrupt request has been serviced. In this example, the interrupt request is serviced by closure of the first and/or second valves 102, 104. If, prior to expiry of the elapsed time limit, the interrupt request has been identified by the flag monitor unit 222 as serviced (indicated by the interrupt flag unit 206 being cleared), the flag monitor unit 222 deactivates and resets the down-counter unit 204 (Step 308).

However, if the interrupt request is not determined to be serviced, the interrupt response control module 200 determines (Step 310) whether the elapsed time limit has expired. If the elapsed time limit has not expired, the flag monitor unit 222 of the interrupt response control module 200 continues to monitor servicing of the interrupt request prior to expiry of the elapsed time limit (Steps 306, 310).

On the other hand, if the elapsed time limit is deemed to have expired, the alternative function multiplexer unit 208 is activated in order to carry out an alternative course of action (Step 312) in the absence of the servicing of the interrupt request by the valve shutoff process.

In this respect, the interrupt response control module 200, via the second configuration port 218, selects a second function in the absence of the first function intended for servicing of the interrupt request.

The second function is a secondary action that can be carried out. For example, the second function can be: initiation of a reset instruction to reset the MCU 112; initiation of an “ignore” instruction to clear the interrupt request and hence remove the interrupt request by clearing the interrupt request flag unit 206 (though this would be undesirable in the present example) via the clear port 220; or change a priority associated with the interrupt request, for example raising or lowering the priority of the interrupt request. Other secondary actions can also or alternatively be provided in order to place the MCU 112 into a deterministic state. For example, an overriding action such as a non-maskable interrupt can be generated, a hardware state in which external pins (not shown) of the MCU 112 are forced into a pre-programmed state can be entered, or a “limp home” or an alternative run mode can be entered in order to protect operation of the MCU 112. The “limp home mode” can be a simple but safe level of functionality that, for example, flashes an error Light Emitting Diode (not shown) of the washing machine 100 in order to alert a user of the washing machine 100 that the washing machine 100 is not functioning correctly, and prevent a door (also not shown) being opened whilst the water in the drum is at a temperature that can harm the user.

In the present example, the secondary action is the initiation of the reset instruction, thereby causing the MCU 112 to reset and restart execution of executable code provided for the MCU 112 to control the washing machine 100. Consequently, the restart would cause the first and second valves 102, 104 to close by removal of control signals to the first and second valves 102, 104. At the same time, the restart causes the executable code to return to an operational state.

As will be appreciated by the skilled person, the above-mentioned embodiment constitutes only one example of a number of applications capable of employing the interrupt response control module 200 in relation to a processing resource. Consequently, other embodiments are set out below, but should not be considered as an exhaustive set of applications capable of employing the interrupt response control module 200.

In an alternative embodiment, an automobile dashboard typically includes a clock that displays a current time for a driver of the automobile. This feature is normally provided by an electronic module that also controls dials, information panels and warning lights mounted in the main dashboard of the automobile. Compared to other information provided by the dashboard, the clock function is relatively unimportant and so operating of the clock function typically has a low priority for a microcontroller. It is important, however, to recognise each clock “tick” and so in circumstances where the clock “tick” function has not been serviced, a priority associated with an interrupt request to increment indication of passage of one or more second in time is increased after a set period of time. Hence, the possibility of the dashboard clock running slower depending upon driving conditions is decreased. In this embodiment the “tick” is typically an event internal to the microcontroller rather than externally generated and the interrupt request control module 200 is arranged to monitor, and increase the priority associated with (if necessary), the interrupt request.

In another embodiment, a printing machine typically has a sensor to determine the presence of a medium to receive print, for example paper or card, waiting to be printed. In this example, the interrupt response module 200 uses an output signal from the sensor to determine when to stop printing and warn the user that the supply of paper needs to be replenished. When the interrupt request is generated corresponding to a detection of lack of paper by the sensor, the interrupt response module 200 normally responds immediately and ceases printing activity. However, if the system has developed some error and code is malfunctioning, then the printing machine could continue to print indefinitely. By using and configuring the interrupt request control module 200, a priority associated with the output signal of the sensor can be raised to ensure prompt reaction to the output signal, or alternatively a reset instruction can be issued to force a correct response to the output signal.

In yet another embodiment, an automobile parked normally sets a timer running which periodically wakes up an Electronic Control Unit (ECU) of the automobile to perform a variety of actions. These actions can include external temperature monitoring (for more efficient engine management), an alarm status check, a proximity check for a driver with a valid key, and/or a presence of rain check to aid in determining whether to force the sunroof to be closed. In all examples, it is important that at some point in time the Electronic Control Unit does respond to the timer and take any necessary actions. The respective priorities of these exemplary actions vary. Use of the interrupt response control module 200 ensures that the timer is always acknowledged within the elapsed time limit. Additionally, or alternatively, the interrupt response control module 200 can raise or lower the relative priorities of servicing the above-mentioned monitoring functions, again based upon an elapsed period of time since each was last acknowledged. If necessary, a reset can be initiated to ensure that the ECU returns to a known error-free operational state.

In still another embodiment, a domestic central heating system comprises a water header tank feeding a boiler, ensuring that water is constantly available for the boiler. Typically a sensor, monitored by an ECU of the boiler, is used to ensure that the boiler constantly receives this water during the heating process. In the event that the water flow ceases, an input signal in the form of an interrupt request issued by the sensor is acknowledged by the ECU and the boiler is turned off. In order to ensure that the interrupt request is acted upon, the interrupt response control module 200 monitors servicing of the interrupt request from the sensor to ensure that the interrupt request is serviced in a timely manner (before expiry of the elapsed time limit) to ensure safe operation of the boiler. Consequently, if the interrupt request is not serviced before expiry of the elapsed time limit, a priority associated with the interrupt request is raised by the alternative function multiplexer unit 208 or the ECU is reset.

It is thus possible to provide an interrupt response apparatus and method of responding to an interrupt request that maintains correct operation of a processing resource implementing an embedded application. In this respect, it is possible to place the processing resource in a known stable state. Additionally, implementation overhead is minimal resulting in a relatively inexpensive mechanism to maintain correct operation of the processing resource.

Further, where a stimulus is no longer valid, the need for additional software to detect and handle the condition is obviated. Of course, the above examples are exemplary, and these or other advantages may be achieved by the invention. Further, the skilled person will appreciate that not all advantages stated above are necessarily achieved by embodiments described herein.

1. An interrupt response control apparatus comprising:
an input for receiving an interrupt request;
a response monitor module arranged to detect performance of a first function for responding to the interrupt request;
a timer (204) arranged to determine an elapsed period of time; characterised by:
a function initiation module arranged to initiate a second function in response to the first function not being performed within the elapsed period of time, the second function being a secondary action selectable from a plurality of secondary actions.

2. An apparatus as claimed in claim 1, wherein the second function modifies a response to the interrupt request by the first function.

3. An apparatus as claimed in claim 1, wherein the interrupt request is triggered by a stimulus external to the input.

4. An apparatus as claimed in claim 1, wherein the second function is a reset function.

5. An apparatus as claimed in claim 1, wherein the second function modifies a priority associated with the interrupt request.

6. An apparatus as claimed in claim 1, further comprising an interrupt flag for recording triggering of the interrupt request.

7. An apparatus as claimed in claim 6, wherein the second function clears the interrupt flag.

8. An apparatus as claimed in claim 1, wherein the second function countermands the interrupt request, thereby preventing the first function responding to the interrupt request.

9. An apparatus as claimed in claim 6, wherein the function initiation module is arranged to initiate the second function in response to the interrupt flag remaining uncleared after the elapsed period of time.

10. An apparatus as claimed in claim 1, wherein the second function constitutes an alternative response to the interrupt request.

11. A processing resource apparatus comprising:
the interrupt response apparatus as claimed in claim 1.

12. An apparatus as claimed in claim 11, wherein the second function is arranged to place the processing resource apparatus in a deterministic operating state.

13. An apparatus as claimed in claim 11, wherein the second function comprises execution of code for protecting operation of the processing resource apparatus.

14. A method of responding to an interrupt request, the method comprising:
receiving the interrupt request;
detecting performance of a first function in response to the interrupt request;
monitoring elapse of a period of time; and
initiating a second function in response to the first function not being performed within the elapsed period of time, the second function being a secondary action selectable from a plurality of secondary actions.

15. A computer program element comprising computer program code means to make a computer execute the method as claimed in claim 14.

16. A computer program element as claimed in claim 15, embodied on a computer readable medium.

17. The method of claim 14, wherein the second function modifies a response to the interrupt request by the first function.

18. The method of claim 14, wherein the second function is a reset function.

19. The method of claim 14, wherein the second function contermands the interrupt request, thereby preventing the first function responding to the interrupt request.

20. The method of claim 14, wherein the second function constitutes an alternative response to the interrupt request.
